(19) United States
(12) Patent Application Publication
(10) Pub. No.: US 2009/0094110 A1
(43) Pub. Date: Apr. 9, 2009

(54) Flexible savings system

(76) Inventor: Mohammad M. Hoque, Lakeville, MN (US)

Correspondence Address: BERGGREN LAW OFFICES, LLC, 7090 43RD STREET NORTH, OAKDALE, MN, 55128, US

(21) Appl. No.: 11/973,175

(22) Filed: Oct. 5, 2007

(51) Int. Cl. G06Q 40/00; G06Q 30/00

(52) U.S. Cl. 705/14; 705/35; 705/39

(57) ABSTRACT

A savings system, method, and apparatus that combines benefits of a layaway payment plan, a traditional Christmas savings bank account and individual savings accounts and also are able to take advantage of merchant promotional offers. The system for saving for an internet purchase includes an adjustable electronic savings structure that permits at least one end-user to create at least one flexible electronic layaway account for a topic of savings. The end user has flexibility as to how much to save, when to save and for what to save, including the ability to change to a different topic of savings.

### FIELD OF THE INVENTION

This invention relates to a system for saving for purchases via the internet without being committed until final purchase.

### BACKGROUND OF THE INVENTION

There is a need for an electronic system that allows a person to save for a purchase but be able to buy a different purchase at any point until the purchase is concluded.

Traditional savings methods do not meet the needs of the internet generation. There is a significant and growing number of individuals who browse the internet looking for items to purchase but do not purchase because they do not have the money, do not wish to use credit, or cannot make up their minds in an area with fast changing merchandise selections. Layaway accounts, offered in various forms for years and most recently over the internet, take advantage of merchant promotional offers but are inflexible in payments and merchandise received. Traditional Christmas savings bank accounts allow flexible savings but do not focus on specific merchandise. Individual saving accounts for specific items are flexible but do not take advantage of merchant promotional offers.

To respond to consumer demand for a wider choice of goods and services, electronic business on the internet is growing and changing. Current methods used in the internet are focused on instant payment for specified items, typically with cash or credit card, or a layaway system for specific items. Online checkouts use such methods including PAYPAL®, BILL ME LATER®, GOOGLE CHECKOUT™, and EBILLME™ formerly SECURE EBILL™, or have a customer setup an account with a credit card for billing.

Recently, an electronic layaway system has been introduced called ELAYAWAY™. However, this system is inflexible. A person is unable to change to a different item once the layaway plan has been initiated. Also, the system is only available for stores that use its services.

In addition, there is a need for more flexible ways to save and pay for other items such as, for example, travel, airline tickets and hotel accommodations cannot be purchased with current layaway systems. For the first time, online travel bookings in the US will surpass offline bookings in volume this year. However, these are generally paid for with credit cards.

Thus, there is still a need for a more flexible savings system that is internet-based to allow people to save for purchases.

### SUMMARY OF THE INVENTION

I have invented a savings system and method that combines benefits of a layaway payment plan, a traditional Christmas savings bank account and individual savings accounts and also are able to take advantage of merchant promotional offers. The system for saving for an internet purchase includes an adjustable electronic savings structure that permits at least one end-user to create at least one flexible electronic layaway account for a topic of savings. The end user has flexibility as to how much to save, when to save and for what to save, including the ability to change to a different topic of savings.

I have also invented a method for saving for an internet purchase. The method includes creating an adjustable electronic savings structure that permits at least one end-user to create at least one flexible electronic layaway account for a topic of savings. The end user has flexibility as to how much to save, when to save and for what to save, including the ability to change to a different topic of savings.

In addition, I have invented an apparatus for saving for an internet purchase that comprises three elements. The first element is a database configured with a secure adjustable electronic savings structure that permits at least one end-user to create at least one adjustable electronic savings account for a topic of savings wherein the end user has flexibility as to how much to save, when to save and for what to save, including the ability to change to a different topic of savings prior to date of purchase. The second element is a means for selectively accessing the database by the end user. The third element is at least one receiving entity in secure communication with the site and able to act as a receptacle for savings added.

My invention satisfies a longstanding but previously unsatisfied desire of users to exercise frugal savings practices while engaging in internet commerce. It also allows ecommerce sites to increase business by reaching these users that do not have enough money to purchase a desired item at a current time but do not want to go into debt with use of such vehicles as credit cards. In addition, unlike conventional layaway plans, an end user is able to change the topic of savings up until the date that a purchase is actually made. Moreover, embodiments of the invention may be used by some as a motivational tool and by others to facilitate group purchases.

As used herein:

“Adjustable electronic savings structure” means a secure electronic structure in communication with at least one ecommerce sites and at least one receiving entity where at least one end user has a flexible electronic layaway account.

“Date of purchase” means date when end user is obligated to transfer money from account to a vendor for a purchase of a topic of savings.

“End user” means a person or organized entity that forms a flexible electronic layaway account.

“Flexible electronic layaway account” means an internet accessible savings account wherein the end user has flexibility as to how much to save, when to save and for what to save, including changing to a different targeted topic of savings or vendor.

“General vendor” means a vendor that has not entered into an arrangement with an end user to give an incentive for the end user to focus a layaway topic of savings toward a particular vendor.

“Preferred vendor” means a vendor that has agreed to enter into an arrangement with an end user to give an incentive for the end user to focus a layaway topic of savings toward a particular vendor.

“Receiving entity” means an entity able to receive money transactions in a secure manner and insure the amounts received are available to a user for eventual purchase upon instructions from user.

“Topic of savings” means an item listed on the internet as available for purchase.

### BRIEF DESCRIPTION OF THE DRAWINGS

One or more features of embodiments of the invention are described in the accompanying drawings. The drawings are briefly described below.

FIG. 1 is a flow diagram of an embodiment of the invention that illustrates a high level view of the communication between an ecommerce site and an end user's flexible electronic layaway account.

FIG. 2 is a flow diagram of an embodiment of the invention that illustrates how a user account may be created.

FIG. 3 is a flow diagram of an embodiment of the invention that illustrates how a user may access an account and change various parameters.

FIG. 4 is a flow diagram of an embodiment of the invention that illustrates how a user may add a topic of savings from the site of a preferred vendor.

FIG. 5 is a flow diagram of an embodiment of the invention that illustrates how a user may add a topic of savings from the site of a general vendor.

FIG. 6 is a flow diagram of an embodiment of the invention that illustrates how a purchase price from a preferred vendor may be locked.

FIG. 7 is a flow diagram of an embodiment of the invention that illustrates how selective advertisements from preferred vendors may be communicated to a user.

FIG. 8 is a flow diagram of an embodiment of the invention that illustrates how a user account is managed

FIG. 9 is a flow diagram of an embodiment of the invention that illustrates how a user makes a purchase of a topic of savings.

### DETAILED DESCRIPTION OF SOME EMBODIMENTS OF THE INVENTION

A growing number of people or entities, herein called end users, prefer to shop via the internet but are averse to assuming debt and may not have sufficient cash or liquid reserves to pay for a particular target of purchase. The end user leaves the site unsatisfied and the site loses a sale form an interested party. My invention is a system, method of creating a solution and an apparatus that enables the end user to resolve that dilemma in a manner that is also satisfactory to the purpose of the site. The characteristics of some embodiments of the various aspects of my invention will be discussed in more detail in this section.

The invention is unique and easy to use. Current internet options include electronic debt accounts like credit cards; electronic payment or billing means like PAYPAL®, BILL ME LATER®, GOOGLE CHECKOUT™, and EBILLME™ formerly SECURE EBILL™, or a fixed electronic layaway program like ELAYAWAY™. These options do not address the need for end users to be able to save for a topic of savings with the ability to change the topic or even the provider of the topic. With the rapid evolution of some topics of purchase such as, for example, electronics and travel offerings, saving for a specific topic of savings may not have satisfactory results upon final purchase.

The invention is also easy to use. An end user accesses my invention in a typically convention al manner to create an account. Then, while surfing the internet and observing a particular topic of savings of interest, the end user simply copies the topic of savings onto the account and begins saving for the topic. When the money is accumulated, a purchase can be made. The end user may change to a different vendor and a different topic of savings at any time prior to locking-in the transaction with a particular vendor. Once the transaction is locked-in, the end user may still change the topic of savings until a purchase is actually made.

The end user may be an individual, several individuals or an organized entity. Typically the end user is an individual. However, the end user may be multiple individuals where a group of people are collectively saving for a topic of savings such as, for example, a trip or where one is supplying money and the other is selecting the topic of savings such as, for example, a parent and a child. Also, the end user may be an organized entity where a club or business is saving for a topic of savings.

In the system aspect of the invention, the system for saving for an internet purchase comprises an adjustable electronic savings structure. The structure permits at least one end-user to create at least one flexible electronic layaway account for a topic of savings wherein the end user has flexibility as to how much to save, when to save and for what to save. The end user also has the ability to change to a different topic of savings under some circumstances.

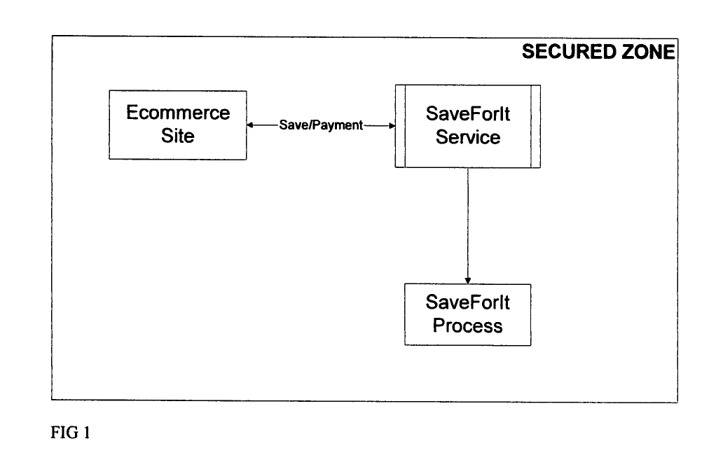

An embodiment is further described in the figures. For illustration purposes, only, my system is described as “SaveForIt”. Other names may be used without limiting the scope of the invention. FIG. 1 is a flow diagram of an embodiment of the invention that illustrates a high level view of communication between the ecommerce site and an end user's flexible electronic layaway account. The communications such as an offer for sale of a topic of savings on an ecommerce site is conveyed to the SaveForIt Structure though a secure entry SaveForIt service portal and is then passed through into the SaveForIt process that contain individual end user flexible layaway accounts. Upon action by an end user, payment is made to the ecommerce site for the topic of savings in effect at that moment.

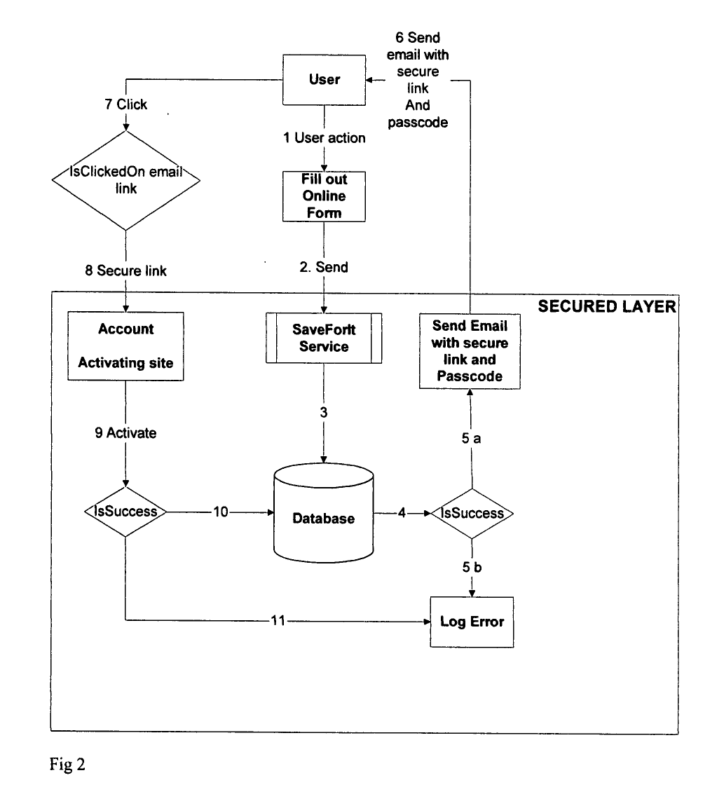

In an embodiment the electronic savings structure is further described as having six elements. The first element of this system is a secure electronic site where the end user can create a secure flexible electronic layaway account by registering information from the group including identification information, a password, a topic of savings, and a method of adding savings. FIG. 2 is a flow diagram of an embodiment of the invention that illustrates how the user account may be created. The end user may access the secure SaveForIt structure by either passing thorough a link on an ecommerce site or by logging on directly. When no account exists, the end user is guided into completing a form and submitting it to the Database through a SaveForIt Service Portal. Once the data is successfully inserted in the database, an email is sent to the user with a secured link and passcode. When the user clicks on the link and enters the passcode, the database is updated to activate the account. Now the user account creation process in done.

The second element is at least one receiving entity in secure communication with the site and able to act as a receptacle for savings added. The receiving entity is an entity able to securely maintain an accounting of financial transactions. Thus, a receiving entity may be any one of a variety of entities such as, for example, banks or businesses with accounting departments. In some embodiments, receiving entities are interest-bearing financial entities. In other embodiments, receiving entities can be stores such as WAL-MART®, or SEARS™.

The third element is a means for adding savings to the account. When setting up a flexible electronic layaway account, the end user typically includes a source of funds that will be used to provide an initial installment of savings. The end user may also list how much is to be transferred from the source to the receiving entity, and how frequently s transfers are to be made. Multiple sources may be entered such as, for example, friends saving for a trip.

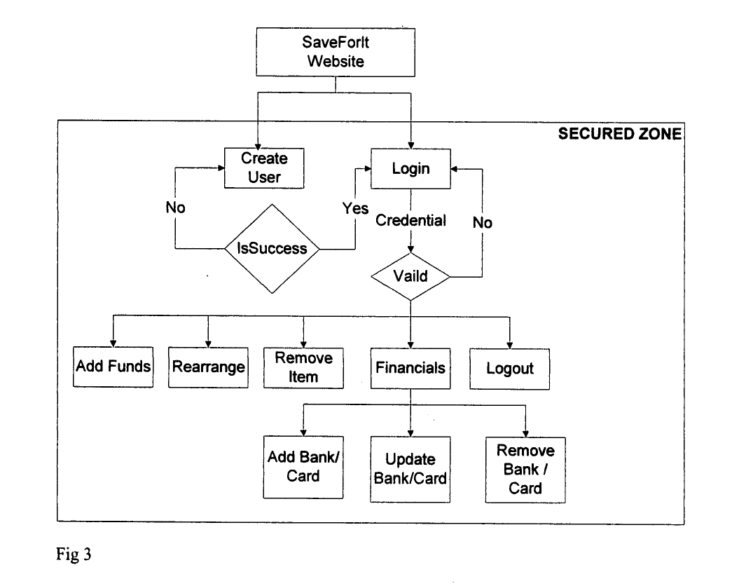

In addition, the end user may change the method of savings. FIG. 3 is a flow diagram of an embodiment of the invention that illustrates how a user may access an account and change various parameters. As seen, the end user has broad control to change the amount and frequency of fund transfer from a source of funds to the flexible electronic layaway account. Also, the end user has the option to add new sources of funds, update existing sources or remove sources.

Funds in the flexible electronic layaway account must be spent eventually on topics of purchase. The funds may be applied to different topics of purchase. Funds may also be applied to topics of purchase from different vendors if the topic of savings is not locked in. However, funds may not be withdrawn as cash to the end user or transferred to accounts accessible by the end user for withdrawal purposes.

The fourth element is a means for selecting at least one topic of savings in the account. Typically the end user first finds a topic of savings on an ecommerce site or through an ecommerce advertisement. Then the end user selects the topic of savings by copying the link into his flexible electronic layaway account. The end user may have more than one link in the account and may have different arrangements for funding each link.

The means for adding savings may be controlled by a different entity than means for selecting a topic of savings. The invention is useful as a source of incentive in such situations as, for example, a parent-child or an employer-employee combination. One may control the means for funding the account while the other may control the means for selecting a topic of savings. Thus a parent or employer may offer an amount of money or varying amounts of installments in a flexible electronic layaway account to a child or employee, respectively, as an incentive for something such as, for example, particular performance. The latter may change the topic of savings or even the vendor but not alter the means for funding the account.

The fifth element is a means for changing target of savings. Until topic of savings is locked in, an end user is free to access the flexible electronic layaway account and change a topic of savings to another from the same vendor or a different vendor. The savings arrangements are transferred with the new topic of savings. The only restrictions are that funds in the flexible electronic layaway account must be spent eventually on topics of purchase and may be applied to different topics of purchase. Funds may not be withdrawn as cash to the end user or transferred to accounts accessible by the end user for withdrawal purposes. But an end user has restricted flexibility of change if the end user locks in a topic of savings with a vendor.

Locking in occurs when an end user modifies the arrangements of a particular topic of savings to make inflexible the choice of a particular vendor. The end user is free to change to another topic of savings available from the vendor but must spend the money associated with that topic of savings on an offering from that vendor. To encourage an end user to lock in a purchase with a particular vendor, vendors may offer incentives such as discounts to assure that the money being saved for a particular topic of savings is eventually spent on something the vendor is selling.

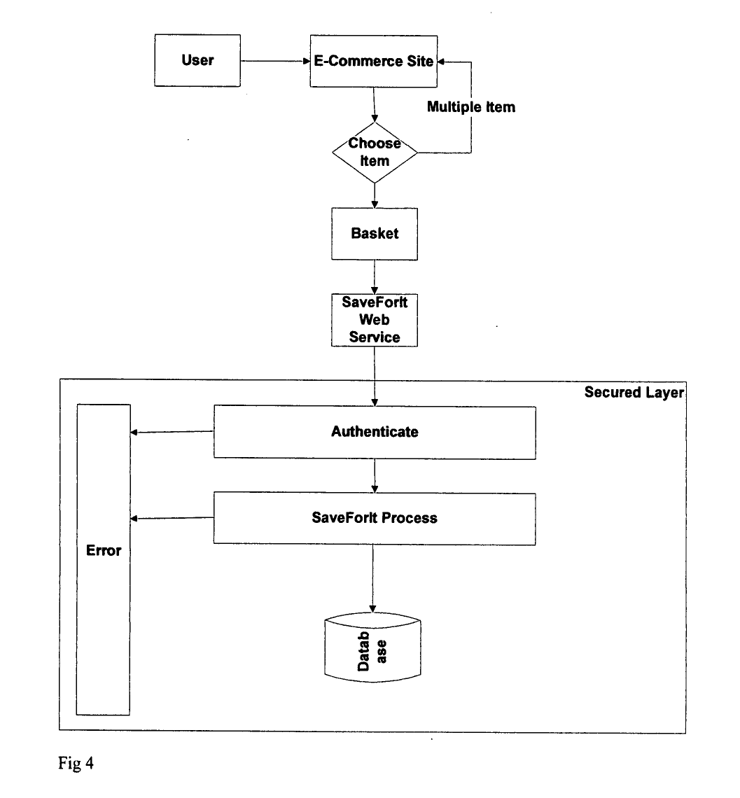

A vendor may be either a preferred vendor or a general vendor. The preferred vendor has an association with the adjustable electronic savings structure of the invention. As such, the preferred vendor displays on the vendor's ecommerce site a link to the adjustable electronic savings structure. Typically the preferred vendor sends specials to the entry portal of the adjustable electronic savings structure to encourage end users to lock in a topic of savings with them. The structure conveys such inducements to interested end users. Typically, preferred vendors do not have direct access to end users until an end user makes a final purchase of a topic of savings. Some embodiments allow direct access at that time while other embodiments do not. FIG. 4 is a flow diagram of an embodiment of the invention that illustrates how a user may add a topic of savings from the site of a preferred vendor.

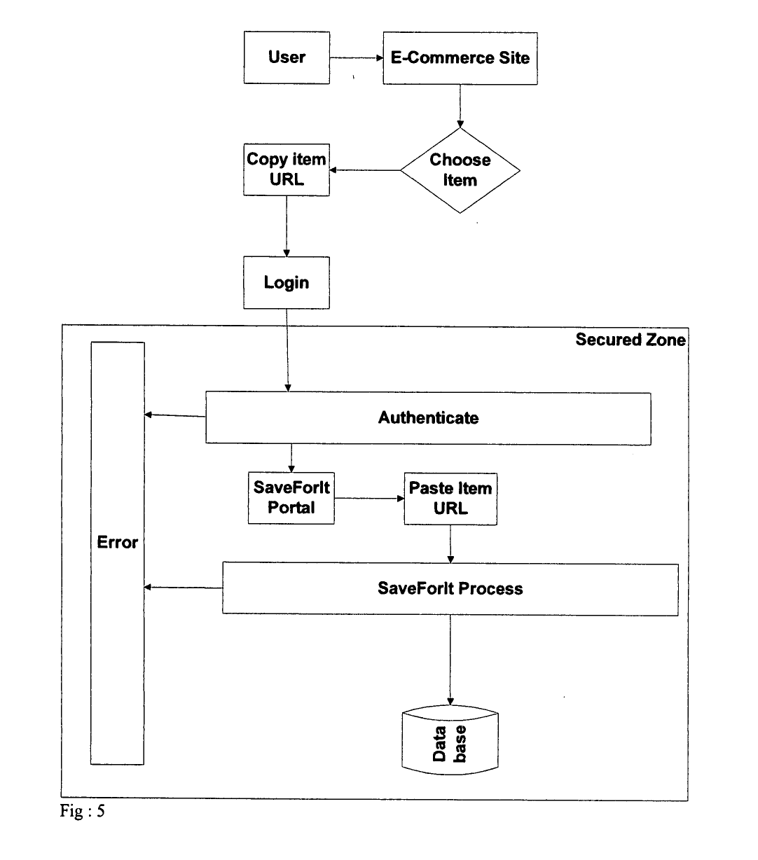

The general vendor has no association with the adjustable electronic savings structure of the invention. An end user happens to identify a topic of savings and cut-and-pastes the item into the flexible electronic layaway account that the end user set up. General vendors may send electronic advertisements related to a list of general categories posted on the home page of the adjustable electronic savings structure of the invention. They may also send communications with incentives for an end user to lock in a topic of savings with them. End users are free to browse this selection for ideas of other topics of savings they may want to add to their accounts or replace for existing topics of savings. But, typically, communications from general vendors are not passed on to end user accounts. FIG. 5 is a flow diagram of an embodiment of the invention that illustrates how a user may add a topic of savings from the site of a general vendor.

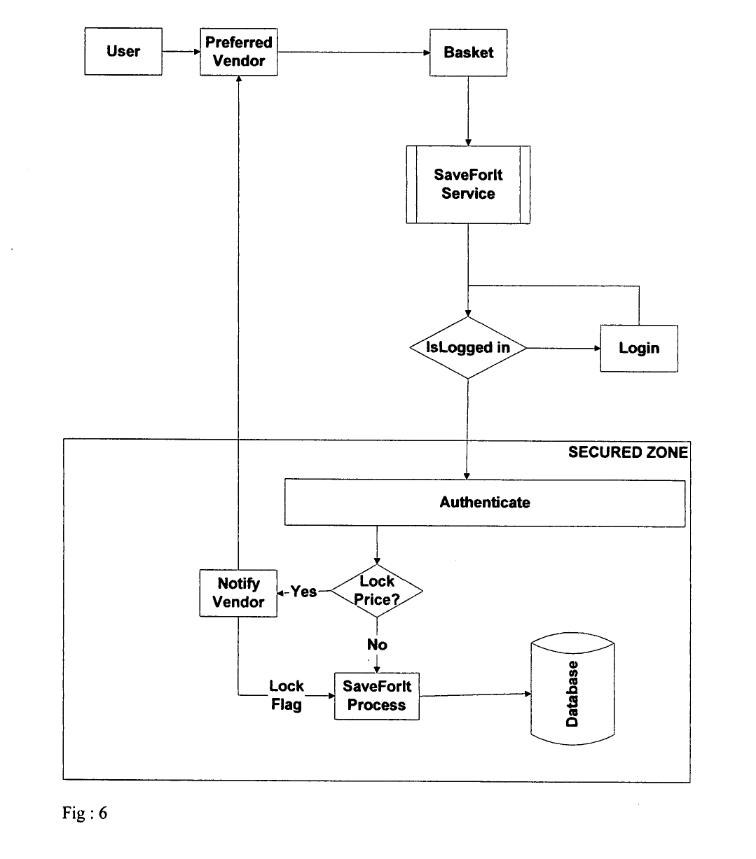

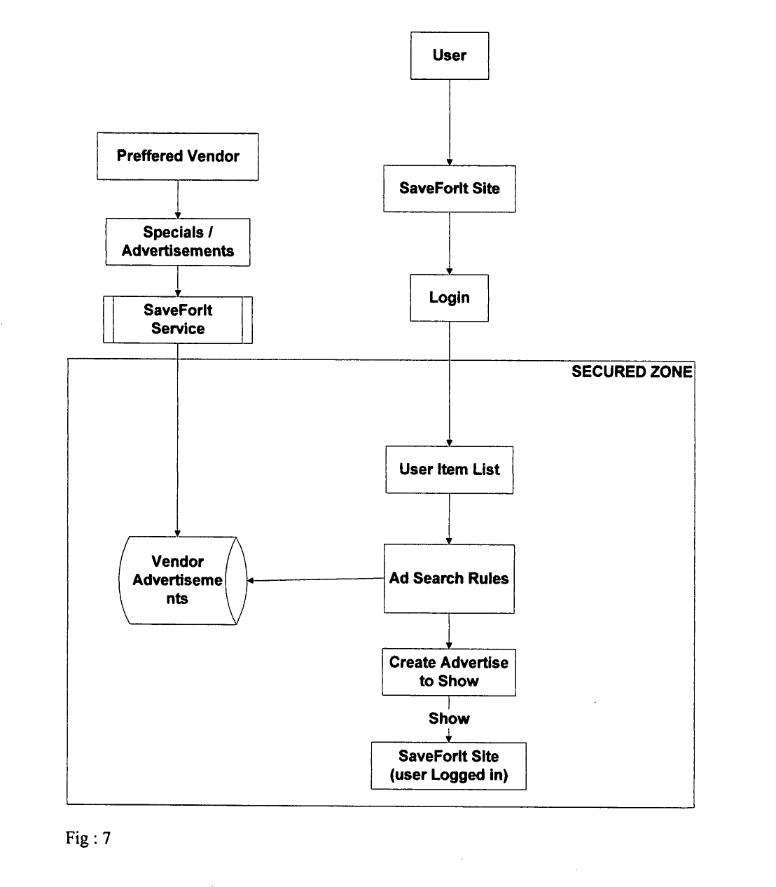

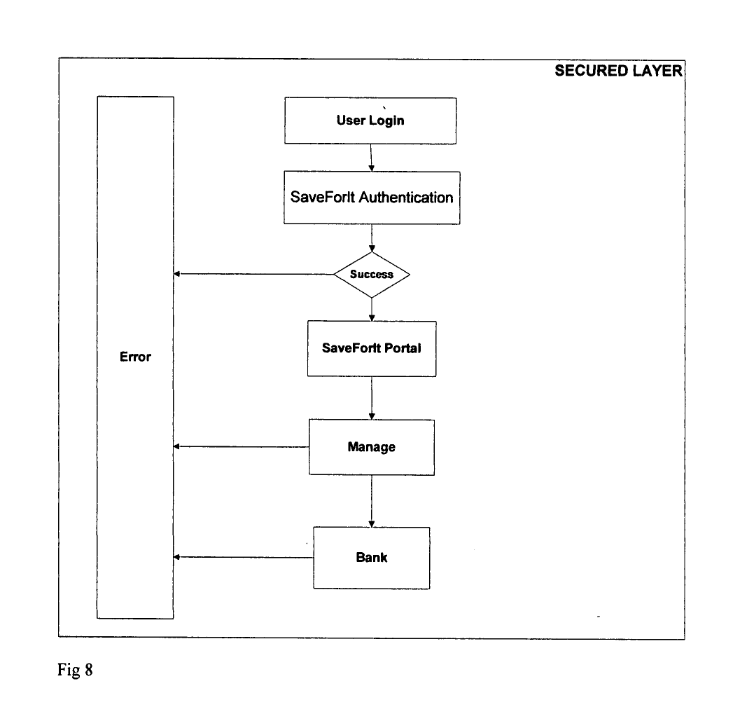

The end user controls the relationship with a general vendor. A general vendor may be locked in by an end user. However, the general user typically would not offer incentives to gain the advantages of being locked in. An end user may request that the adjustable electronic savings structure of the invention contact the general vendor to invite them to become a preferred vendor. In that role, typically vendors will offer incentives to end users to become locked in. FIG. 6 is a flow diagram of an embodiment of the invention that illustrates how a purchase price from a preferred vendor may be locked. FIG. 7 is a flow diagram of an embodiment of the invention that illustrates how selective advertisements from preferred vendors may be communicated to a user. FIG. 8 is a flow diagram of an embodiment of the invention that illustrates how a user account is managed.

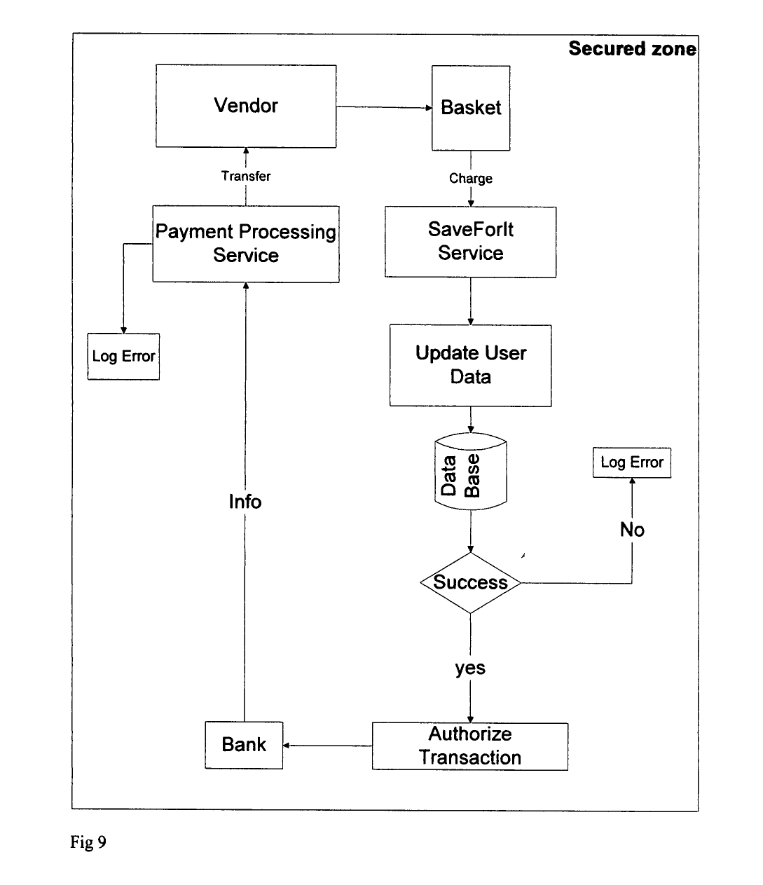

The sixth element is a means for purchasing objects of savings from the account. When an end user has accumulated enough money to purchase a topic of savings and is sure that the topic of savings is still desired, the end user may initiate a purchase. FIG. 9 is a flow diagram of an embodiment of the invention that illustrates how a user makes a purchase of a topic of savings. Typically, only when a purchase is made is the topic of savings unchangeable.

Another aspect of the invention is a method for electronic saving for an internet purchase. The method includes creating an adjustable electronic savings structure that permits at least one end-user to create at least one flexible electronic layaway account for a topic of savings. The end user has flexibility as to how much to save, when to save and for what to save, including the ability to change to a different topic of savings.

In an embodiment the method is further described as having five steps. The first step is providing a secure electronic site where an end user can create a secure savings account by registering information from the group including identification information, password, a topic of savings, and a method of adding savings. The second step is providing at least one receiving entity in secure communication with the site and able to act as a receptacle for savings added. Optionally, the receiving entity may be an interest-earning financial entity. The third step is adding savings to the account. The fourth step is selecting at least one topic of savings in the account that can be changed by end user before date of purchase after the purchase price is accumulated in savings. The fifth step is purchasing the topic of savings from savings. The topic of savings may be changes by the end user at any time until the actual purchase. In addition, the vendor offering the topic of savings may be changed by the end user at any time until either the actual purchase of the topic of savings is locked in.

Still another aspect of the invention is apparatus for electronic saving for an internet purchase. The apparatus comprises three elements. The first element is a database configured to store at least one flexible electronic layaway account that permits at least one end-user to create at least one adjustable electronic savings account for a topic of savings wherein the end user has flexibility as to how much to save, when to save and for what to save, including the ability to change to a different topic of savings prior to date of purchase. The second element is a means for selectively accessing the database by the end user. The third element is at least one receiving entity in secure communication with the site and able to act as a receptacle for savings added. In some embodiments, the receiving entity is an interest-earning financial entity. Also, in some embodiments, the means for selectively accessing the database is also able to receive advertisements related to the topic for purchase from an ecommerce site and make them available to the end user.

The method of making the invention is available to those skilled in the art. The invention may be made by interactively combining databases, means for selective access and the receiving entity to perform the stated function. Databases, means for selectively accessing databases by an end user and receiving entities in communication with the means are well known in other functions. Credit cards are but one example of these elements in interactive communication. The novelty of the invention lies in the unique purpose that the combination is designed to perform. Specific software is easily created once the unique purpose is identified.

Other modifications and changes regarding how an end user may save for a topic of savings in the internet age will be apparent to those skilled in the art. The invention is not considered limited to the embodiments chosen for purposes of disclosure and covers all changes and modifications which do not constitute departures from the true spirit and scope of this invention.

I claim:

1. A system for saving for an internet purchase, comprising, an adjustable electronic savings structure that permits at least one end-user to create at least one flexible electronic layaway account for a topic of savings wherein the end user has flexibility as to how much to save, when to save and for what to save, including the ability to change to a different topic of savings.

2. The system of claim 1 wherein the structure, comprises,
a. a secure electronic site where an end user can create a secure savings account by registering information from the group including identification, password, topic of savings and method of adding savings,
b. at least one receiving entity in secure communication with the site and able to act as a receptacle for savings added,
c. means for adding savings to the account,
d. means for selecting at least one topic of savings in the account,
e. means for changing target of savings, and
f. means for purchasing objects of savings from the account.

3. The system of claim 2 wherein the receiving entity is an interest-earning financial entity.

4. The system of claim 2, further comprising, means for changing means for adding savings.

5. The system of claim 2, further comprising, means for changing vendor of topic of savings.

6. The system of claim 2, further comprising, means for locking-in vendor of topic of savings.

7. The system of claim 2, further comprising, means for obtaining promotional offers relating to topic of savings unsolicited by end user.

8. The system of claim 2, further comprising, means for making vendor preferred vendor of topic of savings.

9. The system of claim 8, further comprising, means for obtaining promotional offers relating to topic of savings unsolicited by end user from preferred vendor.

10. The system of claim 2 wherein end user may be a person or an entity.

11. The system of claim 2 wherein means for adding savings may be controlled by a different entity than means for selecting topic of savings.

12. The system of claim 2 wherein means for adding savings may be controlled by more that one entity.

13. A method for saving for an internet purchase, comprising, creating an adjustable electronic savings structure that permits at least one end-user to create at least one flexible electronic layaway account for a topic of savings wherein the end user has flexibility as to how much to save, when to save and for what to save, including the ability to change to a different topic of savings.

14. The method of claim 13 wherein the structure, comprises,
a. providing a secure electronic site where an end user can create a secure savings account by registering information from the group including identification, password, topic of savings and method of adding savings,
b. providing at least one receiving entity in secure communication with the site and able to act as a receptacle for savings added,
c. adding savings to the account, and
d. selecting at least one topic of savings in the account that can be changed by end user before date of purchase, and
e. purchasing the topic of savings from savings.

15. The system of claim 14 wherein the receiving entity is an interest-earning financial entity.

16. The system of claim 14 wherein the adding of savings can be changed by the end user.

17. The method of 14, wherein the vendor of the topic of savings may be changed by the end user until the topic of savings is locked in or purchased.

18. An apparatus for saving for an internet purchase, comprising,
a. a database able to store at least one flexible electronic layaway account that permits at least one end-user to create at least one adjustable electronic savings account for a topic of savings wherein the end user has flexibility as to how much to save, when to save and for what to save, including the ability to change to a different topic of savings prior to date of purchase,
b. means for selectively accessing the database by the end user, and
c. at least one receiving entity in secure communication with the site and able to act as a receptacle for savings added.

19. The apparatus of claim 18 wherein the receiving entity is an interest-earning financial entity.

20. The apparatus of claim 18 wherein the means for selectively accessing the database is also able to receive advertisements related to the topic for purchase from an ecommerce site and make them available to the end user.
